(19) United States
(12) Patent Application Publication
(10) Pub. No.: US 2023/0420179 A1
(43) Pub. Date: Dec. 28, 2023

(54) COIL COMPONENT

(71) Applicant: SAMSUNG ELECTRO-MECHANICS CO., LTD., Suwon-si (KR)

(72) Inventors: Jae Hun KIM, Suwon-si (KR); Boum Seock KIM, Suwon-si (KR); Ju Hwan YANG, Suwon-si (KR); Woo Jin LEE, Suwon-si (KR)

(73) Assignee: SAMSUNG ELECTRO-MECHANICS CO., LTD., Suwon-si (KR)

(21) Appl. No.: 18/103,967

(22) Filed: Jan. 31, 2023

(30) Foreign Application Priority Data
Jun. 22, 2022 (KR) 10-2022-0076042

(51) Int. Cl. H01F 27/30; H01F 27/29; H01F 27/28; H01F 27/24; H01F 27/32

(52) U.S. Cl. CPC H01F 27/306; H01F 27/292; H01F 27/2852; H01F 27/24; H01F 27/323

(57) ABSTRACT

A coil component includes a body, an insulating layer disposed in the body, at least one first coil disposed on a first surface of the insulating layer, at least one second coil disposed on a second surface of the insulating layer, a plurality of conductive vias connecting the at least one first coil and the at least one second coil, a first external electrode disposed on the body and connected to the at least one first coil; and a second external electrode disposed on the body and connected to the at least one second coil, wherein at least two conductive vias, among the plurality of conductive vias, include a plurality of side surfaces, respectively, and at least one side surface, among the plurality of side surfaces, is at least partially uncovered by and exposed from the insulating layer.

### CROSS-REFERENCE TO RELATED APPLICATION(S)

This application claims benefit of priority to Korean Patent Application No. 10-2022-0076042 filed on Jun. 22, 2022 in the Korean Intellectual Property Office, the disclosure of which is incorporated herein by reference in its entirety.

### TECHNICAL FIELD

The present disclosure relates to a coil component.

### BACKGROUND

With the miniaturization and thinning of electronic devices such as digital TVs, mobile phones, and notebook computers, there is need for the miniaturization and thinning of coil components applied to such electronic devices, and in order to meet this need, research and development of various winding-type or thin film-type coil components are actively progressing.

A major issue with the miniaturization and thinning of coil components is to realize the same characteristics as those of existing coil components, despite the miniaturization and thinning thereof. In order to satisfy these needs, a ratio of a magnetic material in a core in which the magnetic material may be charged should be increased, but there may be a limit to increasing the ratio due to changes in frequency characteristics according to strength and insulation of a body of an inductor.

Meanwhile, a miniaturized thin film-type power inductor may include a conductive via for electrical connection between coil layers. To ensure alignment between the conductive via and the coil layers, a via pad having a greater line width, compared to an end portion of an innermost turn of a coil pattern, may be formed. However, in this case, a size of a core may not be sufficiently secured due to an area of the via pad, and thus magnetic characteristics of a coil component may be deteriorated.

### SUMMARY

An aspect of the present disclosure is to realize a coil component having excellent characteristics while being advantageous for miniaturization by sufficiently securing a size of a core.

According to an aspect of the present disclosure, a coil component includes a body, an insulating layer disposed in the body, at least one first coil disposed on a first surface of the insulating layer, at least one second coil disposed on a second surface of the insulating layer, a plurality of conductive vias connecting the at least one first coil and the at least one second coil, a first external electrode disposed on the body and connected to the at least one first coil, and a second external electrode disposed on the body and connected to the at least one second coil, wherein at least two conductive vias, among the plurality of conductive vias, include a plurality of side surfaces, respectively, and at least one side surface, among the plurality of side surfaces, is at least partially uncovered by and exposed from the insulating layer.

In an embodiment, the plurality of side surfaces may include an exposed side surface, uncovered by and exposed from the insulating layer, and the exposed side surface may be coplanar with one side surface of the insulating layer.

In an embodiment, the exposed side surface may be coplanar with one side surface of the at least one first coil and one side surface of the at least one second coil.

In an embodiment, the exposed side surface may be a flat surface.

In an embodiment, the exposed side surface may be exposed in a direction toward a core of the at least one first coil or a core of the at least one second coil.

In an embodiment, the plurality of side surfaces may include an unexposed side surface, covered by a portion of the insulating layer, and the unexposed side surface may include a curved surface.

In an embodiment, in the plurality of conductive vias, a maximum width measured in a line width direction of the at least one first coil and the at least one second coil may be greater than half of a width of the exposed side surface measured in a direction, perpendicular to the line width direction.

In an embodiment, one end of the at least one first coil may be connected to the first external electrode, and a region on an opposite end of the at least one first coil, connected to the plurality of conductive vias, is referred to as a first pad region. A line width of the first pad region in the at least one first coil may be substantially equal to a line width of a different region of the at least one first coil connected to the first pad region.

In an embodiment, one end of the at least one first coil may be connected to the first external electrode, and a region on an opposite end of the at least one first coil, connected to the plurality of conductive vias, is referred to as a first pad region. A line width of the first pad region in the at least one first coil may be greater than a line width of a different region of the at least one first coil connected to the first pad region.

In an embodiment, a line width of the first pad region may be greater than or equal to a width of the conductive vias measured in the line width direction and less than or equal to twice the width of the conductive vias measured in the line width direction.

In an embodiment, one end of the at least one second coil may be connected to the second external electrode, and a region on an opposite end of the at least one second coil, connected to the plurality of conductive vias, is referred to as a second pad region. A line width of the second pad region in the at least one second coil may be substantially equal to a line width of a different region of the at least one second coil connected to the second pad region.

In an embodiment, one end of the at least one second coil may be connected to the second external electrode, and a region on an opposite end of the at least one second coil, connected to the plurality of conductive vias, is referred to as a second pad region, a line width of the second pad region in the at least one second coil may be greater than a line width of a different region of the at least one second coil connected to the second pad region.

In an embodiment, a line width of the second pad region may be greater than or equal to a width of the conductive vias measured in the line width direction and less than or equal to twice the width of the conductive vias measured in the line width direction.

In an embodiment, the plurality of conductive vias may be arranged in one direction.

In an embodiment, the plurality of conductive vias may include three or more of conductive vias.

According to another aspect of the present disclosure, a coil component includes a body; an insulating layer disposed in the body; at least one first coil and at least one second coil disposed on opposing surfaces of the insulating layer; a plurality of conductive vias spaced apart from one another and connecting the at least one first coil and the at least one second coil through the insulating layer; a first external electrode and a second external electrode disposed on the body and connected to the at least one first coil and the at least one second coil, respectively. A portion of each of the plurality of conductive vias is exposed from a side surface of the insulating layer.

According to still another aspect of the present disclosure, a coil component includes a body; an insulating layer disposed in the body; at least one first coil disposed on a first surface of the insulating layer; at least one second coil disposed on a second surface of the insulating layer; at least one conductive via connecting the at least one first coil and the at least one second coil; a first external electrode disposed on the body and connected to the at least one first coil; and a second external electrode disposed on the body and connected to the at least one second coil. The at least one conductive via includes a side surface at least partially exposed from the insulating layer, and the at least one first coil includes a first pad region to which the at least one conductive via is connected, and a line width of the first pad region in the at least one first coil is substantially equal to a line width of a different region of the at least one first coil connected to the first pad region.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a transparent perspective view schematically illustrating a coil component of an embodiment of the present disclosure.

FIG. 2 is a partially enlarged view of FIG. 1, and is an assembly view illustrating a connection relationship between components.

FIG. 3 is a plan view illustrating an enlarged portion of FIG. 1.

FIGS. 4 and 5 are cross-sectional views of one portion of the coil component of FIG. 1.

FIGS. 6, 7 and 8 illustrate coil components according to modified examples.

FIGS. 9A and 9B are cross-sectional views for each process illustrating a process of manufacturing a coil component.

### DETAILED DESCRIPTION

Hereinafter, embodiments of the present disclosure will be described with reference to specific embodiments and the accompanying drawings. Embodiments of the present disclosure may be modified in various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

Various types of electronic components may be used in electronic devices, and among these electronic components, various types of coil components may be appropriately used for a purpose of removing noise or the like. For example, a coil component in an electronic device may be used as a power inductor, a high frequency (HF) inductor, a general bead, a high frequency (GHz) bead, a common mode filter, and the like.

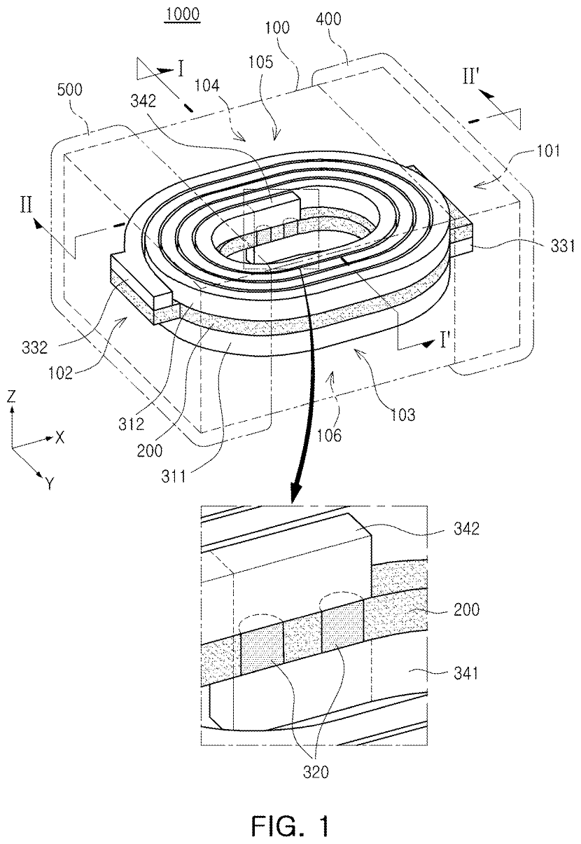

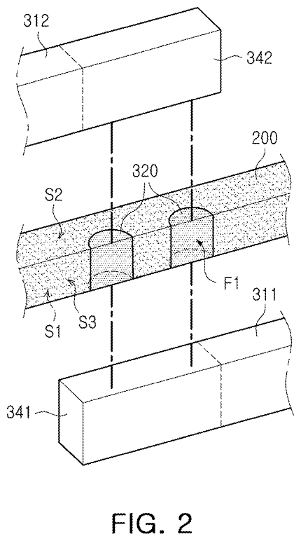

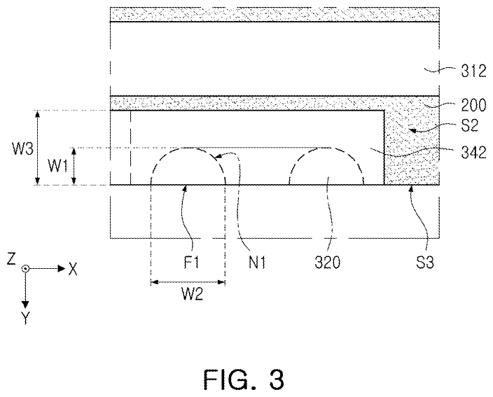

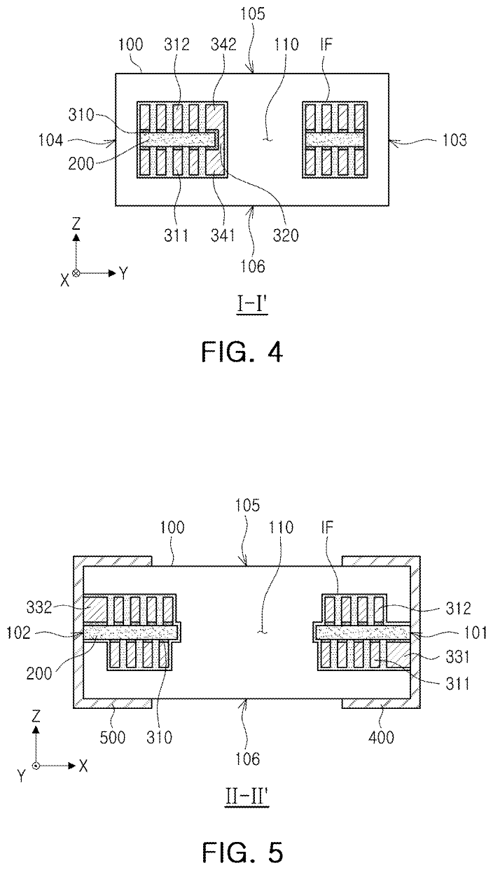

FIG. 1 is a transparent perspective view schematically illustrating a coil component of an embodiment of the present disclosure. FIG. 2 is a partially enlarged view of FIG. 1, and is an assembly view illustrating a connection relationship between components. FIG. 3 is a plan view illustrating an enlarged portion of FIG. 1. FIGS. 4 and 5 are cross-sectional views of one portion of the coil component of FIG. 1.

Referring to FIGS. 1 to 5 together, a coil component 1000 according to the present embodiment may include a body 100, an insulating layer 200, a first coil 311, a second coil 312, a plurality of conductive vias 320, a first external electrode 400, and a second external electrode 500. In this case, at least two conductive vias 320, among the plurality of conductive vias 320, may include a plurality of side surfaces F1 and N1, respectively, and at least one F1, among the plurality of side surfaces F1 and N1, may be at least partially uncovered by and exposed from the insulating layer 200. Hereinafter, main elements constituting the coil component 1000 of the present embodiment will be described.

The body 100 may form an exterior of the coil component 1000, and the coils 311 and 312, and the insulating layer 200 may be disposed therein. As illustrated, the body 100 may be formed to have a hexahedral shape as a whole. The body 100 may include a first surface 101 and a second surface 102 facing each other in a first direction (an X-direction), a third surface 103 and a fourth surface 104 facing each other in a second direction (a Y-direction), and a fifth surface 105 and a sixth surface 106 facing in a third direction (a Z-direction). As an example, in the body 100, the coil component 1000 according to the present embodiment in which the external electrodes 400 and 500 to be described later are formed may be formed to have a length of 2.5 mm, a width of 2.0 mm, and a thickness of 1.0 mm, have a length of 2.0 mm, a width of 1.2 mm, and a thickness of 0.65 mm, have a length of 1.6 mm, a width of 0.8 mm, and a thickness of 0.8 mm, have a length of 1.0 mm, a width of 0.5 mm, and a thickness of 0.5 mm, or have a length of 0.8 mm, a width of 0.4 mm, and a thickness of 0.65 mm, but the present disclosure is not limited thereto. Since the above-described numerical values are merely numerical values on a design that do not reflect a process error or the like, it should be considered that a range that may be recognized as process errors falls within the scope of the present disclosure.

A length of the above-described coil component 1000 in the first direction (the X-direction) may mean a maximum value among dimensions of each of a plurality of line segments, respectively connecting two (2) opposite outermost boundary lines of the coil component 1000 in the first direction (the X-direction), illustrated in an optical microscope or a scanning electron microscope (SEM) photograph for a first direction (X-direction)-third direction (Z-direction) cross-section in a central portion of the coil component 1000 in the second direction (the Y-direction), and parallel to the first direction (the X-direction), based on the cross-sectional photograph. Alternatively, the length of the above-described coil component 1000 in the first direction (the X-direction) may mean a minimum value among dimensions of each of a plurality of line segments, respectively connecting two (2) opposite outermost boundary lines of the coil component 1000 in the first direction (the X-direction), illustrated in the cross-sectional photograph, and parallel to the first direction (the X-direction). Alternatively, the length of the above-described coil component 1000 in the first direction (the X-direction) may mean an arithmetic mean value of at least three or more, among dimensions of each of a plurality of line segments, respectively connecting two (2) opposite outermost boundary lines of the coil component 1000 in the first direction (the X-direction), illustrated in the cross-sectional photograph, and parallel to the first direction (the X-direction). In this case, the plurality of line segments parallel to the first direction (the X-direction) may be equally spaced apart from each other in the third direction (the Z-direction), but the scope of the present disclosure is not limited thereto.

A length of the above-described coil component 1000 in the second direction (the Y-direction) may mean a maximum value among dimensions of each of a plurality of line segments, respectively connecting two (2) opposite outermost boundary lines of the coil component 1000 in the second direction (the Y-direction), illustrated in an optical microscope or a scanning electron microscope (SEM) photograph for a first direction (X-direction)-second direction (Y-direction) cross-section in a central portion of the coil component 1000 in the third direction (the Z-direction), and parallel to the second direction (the Y-direction), based on the cross-sectional photograph. Alternatively, the length of the above-described coil component 1000 in the second direction (the Y-direction) may mean a minimum value among dimensions of each of a plurality of line segments, respectively connecting two (2) opposite outermost boundary lines of the coil component 1000 in the second direction (the Y-direction), illustrated in the cross-sectional photograph, and parallel to the second direction (the Y-direction). Alternatively, the length of the above-described coil component 1000 in the second direction (the Y-direction) may mean an arithmetic mean value of at least three or more, among dimensions of each of a plurality of line segments, respectively connecting two (2) opposite outermost boundary lines of the coil component 1000 in the second direction (the Y-direction), illustrated in the cross-sectional photograph, and parallel to the second direction (the Y-direction). In this case, the plurality of line segments parallel to the second direction (the Y-direction) may be equally spaced apart from each other in the first direction (the X-direction), but the scope of the present disclosure is not limited thereto.

A length of the above-described coil component 1000 in the third direction (the Z-direction) may mean a maximum value among dimensions of each of a plurality of line segments, respectively connecting two (2) opposite outermost boundary lines of the coil component 1000 in the third direction (the Z-direction), illustrated in an optical microscope or a scanning electron microscope (SEM) photograph for a first direction (X-direction)-third direction (Z-direction) cross-section in a central portion of the coil component 1000 in the third direction (the Z-direction), and parallel to the third direction (the Z-direction), based on the cross-sectional photograph. Alternatively, the length of the above-described coil component 1000 in the third direction (the Z-direction) may mean a minimum value among dimensions of each of a plurality of line segments, respectively connecting two (2) opposite outermost boundary lines of the coil component 1000 in the third direction (the Z-direction), illustrated in the cross-sectional photograph, and parallel to the third direction (the Z-direction). Alternatively, the length of the above-described coil component 1000 in the third direction (the Z-direction) may mean an arithmetic mean value of at least three or more, among dimensions of each of a plurality of line segments, respectively connecting two (2) opposite outermost boundary lines of the coil component 1000 in the third direction (the Z-direction), illustrated in the cross-sectional photograph, and parallel to the third direction (the Z-direction). In this case, the plurality of line segments parallel to the third direction (the Z-direction) may be equally spaced apart from each other in the first direction (the X-direction), but the scope of the present disclosure is not limited thereto.

Each of the lengths of the coil component 1000 in the first to third directions may be measured by a micrometer measurement method. The micrometer measurement method may measure the lengths by setting a zero point with a micrometer, reflected with Gage repeatability and reproducibility (R&R), inserting the coil component 1000 according to the present embodiment between tips of the micrometer, and turning a measuring lever of the micrometer. In measuring the lengths of the coil component 1000 by the micrometer measurement method, each of the lengths of the coil component 1000 may mean a value measured once or may mean an arithmetic average of values measured a plurality of times.

The body 100 may include an insulating resin and a magnetic material. Specifically, the body 100 may be formed by laminating one or more magnetic composite sheets in which a magnetic material is dispersed in an insulating resin. The magnetic material may be a ferrite powder particle or a metal magnetic powder particle. Examples of the ferrite powder particle may include at least one or more of spinel type ferrites such as Mg—Zn-based ferrite, Mn—Zn-based ferrite, Mn—Mg-based ferrite, Cu—Zn-based ferrite, Mg—Mn—Sr-based ferrite, Ni—Zn-based ferrite, and the like, hexagonal ferrites such as Ba—Zn-based ferrite, Ba—Mg-based ferrite, Ba—Ni-based ferrite, Ba—Co-based ferrite, Ba—Ni—Co-based ferrite, and the like, garnet type ferrites such as Y-based ferrite, and the like, and Li-based ferrites. The metal magnetic powder particle may include one or more selected from the group consisting of iron (Fe), silicon (Si), chromium (Cr), cobalt (Co), molybdenum (Mo), aluminum (Al), niobium (Nb), copper (Cu), and nickel (Ni). For example, the metal magnetic powder particle may be at least one or more of a pure iron powder, a Fe—Si-based alloy powder, a Fe—Si—Al-based alloy powder, a Fe—Ni-based alloy powder, a Fe—Ni—Mo-based alloy powder, a Fe—Ni—Mo—Cu-based alloy powder, a Fe—Co-based alloy powder, a Fe—Ni—Co-based alloy powder, a Fe—Cr-based alloy powder, a Fe—Cr—Si-based alloy powder, a Fe—Si—Cu—Nb-based alloy powder, a Fe—Ni—Cr-based alloy powder, and a Fe—Cr—Al-based alloy powder. The metal magnetic powder particle may be amorphous or crystalline. For example, the metal magnetic powder particle may be a Fe—Si—B—Cr-based amorphous alloy powder particle, but the present disclosure is not limited thereto. The ferrite powder particle and the metal magnetic powder particle may have an average diameter of about 0.1 μm to 30 μm, respectively, but the present disclosure is not limited thereto. The body 100 may include two or more types of magnetic materials dispersed in the resin. In this case, the term “different types of magnetic materials” means that magnetic materials dispersed in a resin are distinguished from each other by at least one of an average diameter, a composition, a crystallinity, or a shape. The insulating resin may include epoxy, polyimide, a liquid crystal polymer, or the like, in a single form or in combined form, but the present disclosure is not limited thereto.

The body 100 may include a core 110 passing through the insulating layer 200 and the coils 311 and 312, which will be described later. The core 110 may be formed by filling the through-hole 111h passing through centers of the first and second coils 311 and 312 and a center of the insulating layer 200 with a magnetic composite sheet including a magnetic material.

The insulating layer 200 may be disposed in the body 100, and may support the coils 311 and 312. As will be described later, the insulating layer 200 may support a partition wall 230 used in a process of forming the first and second coils 311 and 312, and a central portion of the insulating layer 200 may be removed to form the through-hole 111h. The insulating layer 200 may be trimmed along shapes of pad regions 341 and 342 to be described later to have a shape corresponding to the pad regions 341 and 342. Referring to FIGS. 1 to 4, a via hole 321h, which will be described later, may be partially removed from a side surface of the insulating layer 200 facing the core 110, to forma concave curved surface. This portion of the insulating layer 200 may be in contact with an unexposed side surface N1 of a conductive via 320 to be described later, and may have an inwardly concave arc shape.

The insulating layer 200 may be formed of an insulating material including a thermosetting insulating resin such as an epoxy resin, a thermoplastic insulating resin such as polyimide, or a photosensitive insulating resin, or may be formed of an insulating material in which a reinforcing material such as a glass fiber or an inorganic filler is impregnated with such an insulating resin. For example, the insulating layer 200 may be formed of an insulating material such as a prepreg, an Ajinomoto build-up film (ABF), an FR-4, a bismaleimide triazine (BT) resin, a photoimageable dielectric (PID), and the like, but the present disclosure is not limited thereto. As the inorganic filler, at least one or more selected from a group consisting of silica (silicon dioxide, SiO₂), alumina (aluminum oxide, Al₂O₃), silicon carbide (SiC), barium sulfate (BaSO₄), talc, mud, a mica powder, aluminium hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTiO₃), and calcium zirconate (CaZrO₃) may be used. When the insulating layer 200 is formed of an insulating material including a reinforcing material, the insulating layer 200 may provide better rigidity. When the insulating layer 200 is formed of an insulating material not containing glass fibers, the insulating layer 200 may be advantageous for reducing a thickness of the coil component 1000 according to the present embodiment. In addition, based on the body 100 having the same size, a volume occupied by the coils 311 and 312 and/or the magnetic metal powder may be increased to improve component properties. When the insulating layer 200 is formed of an insulating material including a photosensitive insulating resin, the number of processes for forming the coils 311 and 312 may be reduced. Therefore, it is advantageous in reducing production costs, and the conductive vias 320 may be finely formed. A thickness of the insulating layer 200 may be, for example, 10 μm or more and 50 μm or less, but the present disclosure is not limited thereto.

The first coil 311 may be disposed on one surface Si of the insulating layer 200, and the second coil 312 may be disposed on the other surface S2 of the insulating layer 200. One end of the first and second coils 311 and 312 may be first and second lead-out portions 331 and 332, respectively, and the other end of the first and second coils 311 and 312 may be first and second pad regions 341 and 342, respectively. In this case, the first and second lead-out portions 331 and 332 may be respectively connected to the first and second external electrodes 400 and 500, and the first and second pad regions 341 and 342 may be respectively connected to the plurality of conductive vias 320. The first coil 311 and the second coil 312 may each have a planar spiral shape in which at least one turn may be formed about the core 110 as an axis. The first coil 311 and the second coil 312 may be provided in plural, respectively.

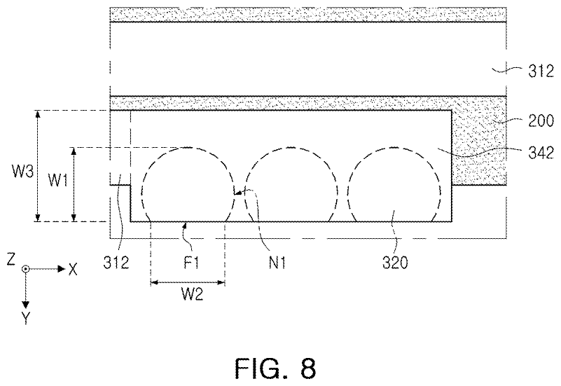

The conductive via 320 may connect the first and second coils 311 and 312, and may be provided as a plurality of conductive vias in the present embodiment. As the plurality of conductive vias 320 are connected, connectivity of the first and second coils 311 and 312 may be improved in structural and electrical aspects. When the plurality of conductive vias 320 are employed, a size of the core 110 of the first and second coils 311 and 312 may be reduced, and therefore, there is a possibility that magnetic properties of the coil component 1000 may be deteriorated. In the present embodiment, a reduction in magnetic properties may be minimized by optimizing shapes and further arrangement of the plurality of conductive vias 320. Specifically, at least two of the plurality of conductive vias 320 may include a plurality of side surfaces F1 and N1, respectively, and at least one F1 of the plurality of side surfaces F1 and N1 may be at least partially uncovered by and exposed from the insulating layer 200. Although the side surface F1 is entirely exposed in the present embodiment, a portion of the side surface F1 may be covered by the insulating layer 200 depending on an embodiment. In the present embodiment, two (2) conductive vias 320 may be provided, but three (3) conductive vias 320 may be included as in the modified examples of FIGS. 7 and 8. In addition, as necessary, to further improve connectivity of the first and second coils 311 and 312, four (4) or more conductive vias 320 may be included. In the present embodiment, if an exposed side surface that may not be covered by the insulating layer 200, among the plurality of side surfaces F1 and N1 of the conductive via 320, is referred to as an exposed side surface F1, an example in which the exposed side surface F1 is one (1) is illustrated, but the exposed side surface F1 may be two (2) or more.

Among the plurality of side surfaces F1 and N1 of the conductive via 320, the exposed side surface F1 may be coplanar with one side surface S3 of the insulating layer 200. In this case, the one side surface S3 of the insulating layer 200 may be a surface facing the core 110. In addition, the exposed side surface F1 of the conductive via 320 may be coplanar with one side surface of the first and second coils 311 and 312, specifically, a surface facing the core 110. Such a coplanar structure may be obtained by simultaneously cutting the conductive via 320 and the insulating layer 200, and further, the first and second coils 311 and 312. In this case, the exposed side surface F1 of the conductive via 320 may be a cut surface, and may be exposed toward the core 110. As in the present embodiment, when the plurality of conductive vias 320 have the exposed side surface F1, a size of a region of the conductive vias 320, the insulating layer 200, and the pad regions 341 and 423, facing the core 110, may be reduced, and therefore, a size of the core 110 may be sufficiently secured. Therefore, as described above, magnetic properties of the coil component 1000 may be also improved by securing a size of the core 110 while improving connectivity between the first and second coils 311 and 312 through the plurality of conductive vias 320.

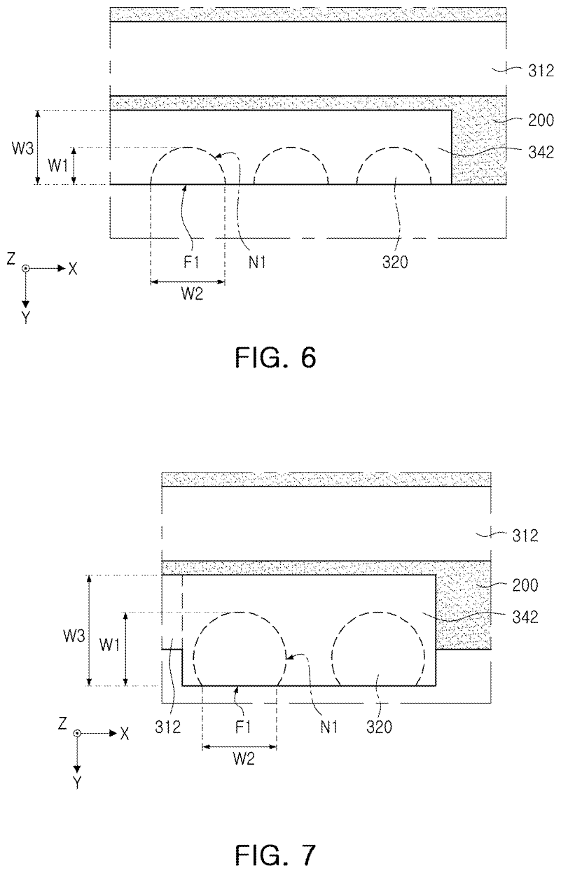

Referring to more specific examples with reference to FIG. 3, when a side covered by the insulating layer 200, among the plurality of side surfaces F1 and N1 of the conductive via 320, is referred to as an unexposed side surface N1, the unexposed side surface N1 may include a curved surface. In addition, in the plurality of vias 320, a maximum width W1 measured in a line width direction (the Y-direction based on the drawings) of the first and second coils 311 and 312 may be greater than half a width W2 of the exposed side surface F1 measured by a direction (the X-direction), perpendicular to the line width direction. By making the maximum width W1 greater than half of the width W2 of the exposed side surface F1, high connectivity between the first and second coils 311 and 312 may be realized. In addition, as illustrated, the plurality of conductive vias 320 may be arranged in one direction and spaced apart from one another with an interval. The one direction may be an extension direction of the first and second coils 311 and 312. When the plurality of conductive vias 320 are provided, arranging them in one direction may be suitable for sufficiently securing a size of the core 110. Although FIG. 3 illustrates the second coil 312, the first coil 311 may also have the same shape, which will be the same for the modified examples of FIGS. 6 to 8.

In addition, in the present embodiment, the pad regions 341 and 342 may have a relatively narrow line width W3, as compared to those of the related art. Specifically, a line width W3 of the first pad region 341 in the first coil 311 may be substantially equal to a line width W3 of a different region connected thereto. Similarly, a line width W3 of the second pad region 342 in the second coil 312 may be substantially equal to a line width W3 of a different region connected thereto. As in the modified example of FIGS. 7 and 8, a line width W3 of the first pad region 341 in the first coil 311 may be greater than a line width W3 of a different region connected thereto. FIG. 7 illustrates an embodiment in which the number of conductive vias 320 is two, FIG. 8 illustrates an embodiment in which the number of conductive vias 320 is three. Similarly, a line width W3 of the second pad region 342 in the second coil 312 may be greater than a line width W3 of a different region connected thereto. In embodiments of FIGS. 3, 7 and 8, a relative size of a width W1 of the conductive via 320 to a line width W3 of each of the pad regions 341 and 342 may be determined in consideration of connectivity of the first and second coils 311 and 312, or the like. Specifically, a line width W3 of the first pad region 341 may be greater than or equal to a width and less than or equal to twice a width W1 of the conductive via 320 measured in a line width direction (the Y-direction), and similarly, a line width W3 of the second pad region 342 may be greater than or equal to a width and less than or equal to twice a width W1 of the conductive via 320 measured in a line width direction (the Y-direction). Compared to the embodiment of FIG. 3, FIGS. 7 and 8 illustrate embodiments in which the width W1 of the conductive via 320 and the line width W3 of each of the pad regions 341 and 342 increase, and may be suitable to further improve connectivity of the first and second coils 311 and 312. The widths W1, W2 and W3 may be measured by a standard method that will be apparent to and understood by one of ordinary skill in the art.

Referring to FIGS. 4 and 5, the first and second coils 311 and 312 may include at least one conductive layer. Specifically, the first and second coils 311 and 312 may be formed by a plating process, and, in this case, may include a seed layer 310 and an electroplating layer. In this case, the electroplating layer may have a single-layer structure or a multilayer structure. In the electroplating layer having a multilayer structure, a conformal film structure in which another electroplating layer is formed along a surface of an electroplating layer may be formed, and a structure in which the other electroplating layer is stacked only on a surface of an electroplating layer may be formed. The seed layer 310 may be formed by an electroless plating method, a vapor deposition method such as sputtering or the like, or the like. The first and second coils 311 and 312 may be integrally formed, with the seed layer 310, and no boundary therebetween may occur, but the present disclosure is not limited thereto. In addition, each of the electroplating layers in the first and second coils 311 and 312 may be integrally formed, and no boundary therebetween may occur, but the present disclosure is not limited thereto. The first and second coils 311 and 312 may be formed of a conductive material such as copper (Cu), aluminum (Al), silver (Ag), tin (Sn), gold (Au), nickel (Ni), lead (Pb), titanium (Ti), or alloys thereof, but the present disclosure is not limited thereto.

An insulating film IF may be formed on surfaces of the first and second coils 311 and 312. The insulating film IF may integrally cover the first and second coils 311 and 312 and the insulating layer 200. Specifically, the insulating film IF may be disposed between the first and second coils 311 and 312 and the body 100, and between the insulating layer 200 and the body 100. The insulating film IF may be formed along surfaces of the insulating layer 200 and the first and second coils 311 and 312, but the present disclosure is not limited thereto. The insulating film IF may be for insulating the first and second coils 311 and 312 and the body 100, and may include a known insulating material such as parylene or the like, but the present disclosure is not limited thereto. As another example, the insulating film IF may include an insulating material such as an epoxy resin or the like, other than parylene. The insulating film IF may be formed by a vapor deposition method, but the present disclosure is not limited thereto. As another example, the insulating film IF may be formed by stacking and curing an insulating film for forming the insulating film IF on both surfaces of the insulating layer 200 on which the coil portion 220 is formed, or may be formed by applying and curing an insulating paste for forming an insulating film IF on both surfaces of the insulating layer 200 on which the coil portion 220 is formed. For the above reasons, the insulating film IF may be a configuration that may be omitted in the present embodiment. For example, when the body 100 has sufficient electrical resistance at a designed operating current and voltage of the coil component 1000, the insulating film IF may be omitted in the present embodiment.

The first and second external electrodes 400 and 500 may be spaced apart from each other on the body 100, and may be respectively connected to the first and second coils 311 and 312. Specifically, the first external electrode 400 may be disposed on the first surface 101 of the body 100 and may be connected to the first lead-out portion 331 exposed from the first surface 101 of the body 100, and, the second external electrode 500 may be disposed on the second surface 102 of the body 100 and may be connected to the second lead-out portion 332 exposed from the second surface 102 of the body 100. The first external electrode 400 may be disposed on the first surface 101 of the body 100, and may extend to at least a portion of the third to sixth surfaces 103, 104, 105, and 106 of the body 100. The second external electrode 500 may be disposed on the second surface 102 of the body 100, and may extend to at least a portion of the third to sixth surfaces 103, 104, 105, and 106 of the body 100. The first and second external electrodes 400 and 500 respectively disposed on the first surface 101 and the second surface 102 of the body 100 may respectively have a structure extending only to the sixth surface 106 of the body 100.

The external electrodes 400 and 500 may be formed by a vapor deposition method such as sputtering and/or a plating method, but the present disclosure is not limited thereto. The external electrodes 400 and 500 may be formed of a conductive material such as copper (Cu), aluminum (Al), silver (Ag), tin (Sn), gold (Au), nickel (Ni), lead (Pb), chromium (Cr), titanium (Ti), alloys thereof, or the like, but the present disclosure is not limited thereto. The external electrodes 400 and 500 may be formed in a single-layer or multilayer structure. For example, the external electrodes 400 and 500 may include a first conductive layer including copper (Cu), a second conductive layer disposed on the first conductive layer and including nickel (Ni), and a third conductive layer disposed on the second conductive layer and including tin (Sn). At least one of the second conductive layer or the third conductive layer may be formed to cover the first conductive layer, but the scope of the present disclosure is not limited thereto. The first conductive layer may be a plating layer, or may be a conductive resin layer formed by coating and curing a conductive resin including a conductive powder including at least one of copper (Cu) or silver (Ag), and a resin. The second and third conductive layers may be plating layers, but the scope of the present disclosure is not limited thereto.

The coil component 1000 according to the present embodiment may further include an external insulating layer disposed on the third to sixth surfaces 103, 104, 105, and 106 of the body 100. The external insulating layer may be disposed in a region, other than a region on which the external electrodes 400 and 500 are disposed. At least a portion of the external insulating layers disposed on each of the third to sixth surfaces 103, 104, 105, and 106 of the body 100 may be formed by the same process as each other, and may be formed to have an integral form in which no boundary is formed between them, but the scope of the present disclosure is not limited thereto. The external insulating layer may be formed by forming an insulating material for forming the external insulating layer by a method such as a printing method, a vapor deposition method, a spray coating method, a film lamination method, or the like, but the present disclosure is not limited thereto. The external insulating layer may include a thermoplastic resin such as a polystyrene-based resin, a vinyl acetate-based resin, a polyester-based resin, a polyethylene-based resin, a polypropylene-based resin, a polyamide-based resin, a rubber-based resin, an acryl-based resin, or the like, a thermosetting resin such as a phenol-based resin, an epoxy-based resin, a urethane-based resin, a melamine-based resin, an alkyd-based resin, or the like, a photosensitive resin, parylene, SiOₓ, or SiNₓ. The external insulating layer may further include an insulating filler such as an inorganic filler, but the present disclosure is not limited thereto.

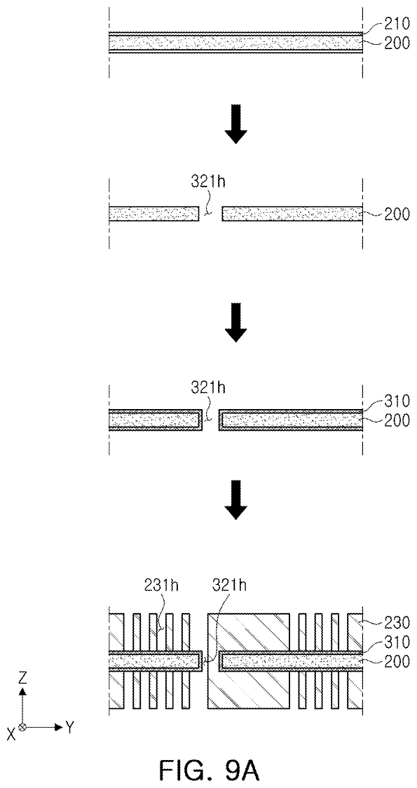

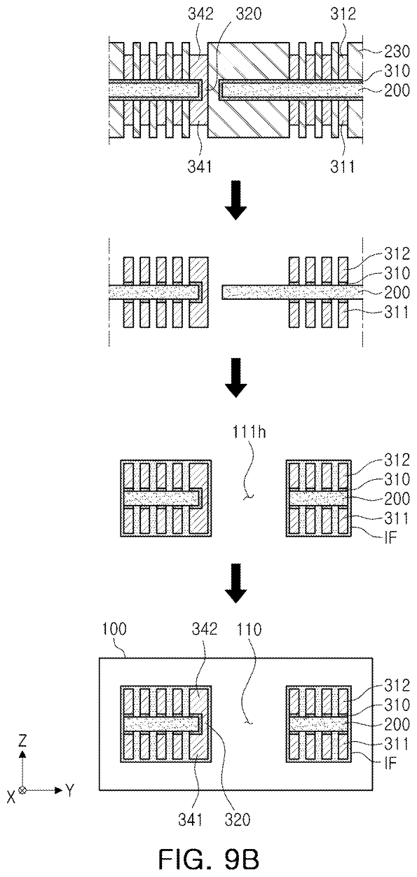

Hereinafter, an example of a method of manufacturing a coil component having the above-described structure will be described. First, FIGS. 9A to 9B are views sequentially illustrating a process of forming a coil using a partition wall method. Referring to FIG. 9A, an insulating layer 200 may be prepared first. The insulating layer 200 may be obtained from a conventional copper clad laminate (CCL) or the like, and in this case, a thin copper foil 210 may be formed on both surfaces thereof. Next, the copper foil 210 may be removed from the insulating layer 200, and a via hole 321h may be formed. The via hole 321h may be formed using a mechanical drill and/or a laser drill. In this case, a process of removing the copper foil 210 may be omitted, and the copper foil 210 itself may be used as a seed, but the present disclosure is not limited thereto. In this case, it is necessary to create a separate seed layer 310 for a side surface of the via hole 321h. Next, the seed layer 310 may be formed on both surfaces of the insulating layer 200 and a wall surface of the via hole 321h. The seed layer 310 may be formed by a known method, and may be formed, for example, by chemical vapor deposition (CVD), physical vapor deposition (PVD), sputtering, or the like, using a dry film or the like, but the present disclosure is not limited thereto.

Next, partition walls 230 may be formed on both surfaces of the insulating layer 200. The partition walls 230 may each be a resist film, and may be formed by a method of laminating and curing the resist film, a method of coating and curing a material of the resist film, or the like, but the present disclosure is not limited thereto. As the lamination method, for example, a method of pressing at a high temperature for a certain period of time, cooling to room temperature under reduced pressure, and cooling in a cold press, to separate a work tool, may be used. As the coating method, a screen-printing method which coats ink with a squeegee, a spray printing method of the system which mists and coats ink, or the like may be used, for example. The curing may be a drying operation, not completely cured, to be used in a photolithography method or the like as a post-process. The partition wall 230 may have an opening 231h having a planar coil shape, and the opening 231h may use a known photolithography method, e.g., a known exposure and development method, and may be sequentially patterned, or may also be patterned once. Exposure equipment or a developer is not particularly limited, and may be appropriately selected and used, according to a photosensitive material to be used. In this case, the partition walls 230 may be arranged to correspond to shapes of the pad regions 341 and 342, and the partition walls 230 may be also arranged in some regions in the via hole 321h, to form a conductive via 320 in the subsequent plating process, according to shapes of the pad regions 341 and 342.

Referring to FIG. 9B, the opening 231h of the partition wall 230 may be used as a plating growth guide, to form first and second coils 311 and 312 on the seed layer 310. In this case, since they are formed by a single plating process, the conductive via 320 and pad regions 341 and 342 may be integrally formed. In this case, a plurality of the conductive via 320 thus formed may be disposed in the via holes 321h, to connect vertically the first and second coils 311 and 312 to each other, and to have an unexposed side surface N1 covered by the insulating layer 200 and an exposed side surface F1 not covered by the insulating layer 200. For example, the plurality of conductive vias 320 may have an unexposed side surface N1 contacting an inner wall of the via hole 321h and an exposed side surface F1 not contacting the inner wall of the via hole 321h. As the first and second coils 311 and 312 and the conductive via 320 are integrally formed in one process as described above, the exposed side surface F1 of the conductive via 320 may be coplanar with one side surface of the insulating layer 200, or one side surface of each of the first and second coils 311 and 312.

In a method of manufacturing the first and second coils 311 and 312 using the partition wall 230, an opening pattern may be first formed in an insulator, and then plating may be performed using the opening pattern as a guide, which may be different from a conventional anisotropic plating technique. Therefore, it is advantageous that it is easy to adjust a shape of a coil conductor. For example, the first and second coils 311 and 312 thus formed may have flat side surfaces contacting the partition wall 230, respectively. In this case, the meaning of being flat may be a concept including not only completely flat, but also substantially flat. For example, it is considered that a wall surface of the opening pattern has a certain roughness by a photolithography method. The plating method is not particularly limited, and electroplating, electroless plating, or the like may be used, but the present disclosure is not limited thereto. Next, after forming the first and second coils 311 and 312, the partition wall 230 may be removed. The partition wall 230 may be removed using a known release agent or the like. In this case, after the partition wall 230 may be removed, the seed layer 310 may be etched, to form a pattern.

Next, a through-hole 111h passing through the insulating layer 200 may be formed by a trimming process. In this process, a portion of the insulating layer 200 and a portion of the conductive via 320 may also be trimmed, and from this, each side surface of the first and second coils 311 and 312, the conductive via 320, and the insulating layer 200, contacting the through-hole 111h, may have a shape corresponding to each other, and may be substantially coplanar. The through-hole 111h may be formed using a mechanical drill and/or a laser drill. The through-hole 111h may be connected to the via hole 321h, to form one hole. During the trimming process, a region passing through not only a central portion but also an outer portion may be formed. For example, in the trimming process, a region passing through the central portion and the outer portion may be formed, such that the insulating layer 200 has a shape corresponding to planar shapes of the first and second coils 311 and 312, and this region may be filled with a magnetic material. Therefore, it is possible to realize better coil properties.

Next, an insulating film IF may be formed to integrally cover the insulating layer 200 and the first and second coils 311 and 312. The insulating film IF may be coated using chemical vapor deposition (CVD) or the like. Finally, magnetic sheets may be laminated to cover the insulating layer 200 and the first and second coils 311 and 312, thus manufactured, to form a body 100, the first and second coils 311 and 312 may be respectively connected to a surface of the body 100 thus formed, and first and second external electrodes 400 and 500 may be disposed to be spaced apart from each other.

As an effect of the present disclosure, it is possible to realize a coil component having excellent characteristics while being advantageous for miniaturization by sufficiently securing a size of a core.

While example embodiments have been illustrated and described above, it will be apparent to those skilled in the art that modifications and variations could be made without departing from the scope of the present disclosure as defined by the appended claims.

What is claimed is:

1. A coil component comprising:
a body;
an insulating layer disposed in the body;
at least one first coil disposed on a first surface of the insulating layer;
at least one second coil disposed on a second surface of the insulating layer;
a plurality of conductive vias connecting the at least one first coil and the at least one second coil;
a first external electrode disposed on the body and connected to the at least one first coil; and
a second external electrode disposed on the body and connected to the at least one second coil,
wherein at least two conductive vias, among the plurality of conductive vias, include a plurality of side surfaces, respectively, and
at least one side surface, among the plurality of side surfaces, is at least partially uncovered by and exposed from the insulating layer.

2. The coil component of claim 1, wherein the plurality of side surfaces includes an exposed side surface uncovered by and exposed from the insulating layer, and the exposed side surface is coplanar with one side surface of the insulating layer.

3. The coil component of claim 2, wherein the exposed side surface is coplanar with one side surface of the at least one first coil and one side surface of the at least one second coil.

4. The coil component of claim 2, wherein the exposed side surface is a flat surface.

5. The coil component of claim 2, wherein the exposed side surface is exposed in a direction toward a core of the at least one first coil or a core of the at least one second coil.

6. The coil component of claim 2, wherein the plurality of side surfaces includes an unexposed side surface covered by a portion of the insulating layer, and the unexposed side surface comprises a curved surface.

7. The coil component of claim 6, wherein, in the plurality of conductive vias, a maximum width measured in a line width direction of the at least one first coil and the at least one second coil is greater than half of a width of the exposed side surface measured in a direction, perpendicular to the line width direction.

8. The coil component of claim 1, wherein one end of the at least one first coil is connected to the first external electrode, and a region on an opposite end of the at least one first coil, connected to the plurality of conductive vias, is referred to as a first pad region, and
a line width of the first pad region in the at least one first coil is substantially equal to a line width of a different region of the at least one first coil connected to the first pad region.

9. The coil component of claim 1, wherein one end of the at least one first coil is connected to the first external electrode, and a region on an opposite end of the at least one first coil, connected to the plurality of conductive vias, is referred to as a first pad region,
a line width of the first pad region in the at least one first coil is greater than a line width of a different region of the at least one first coil connected to the first pad region.

10. The coil component of claim 8, wherein a line width of the first pad region is greater than or equal to a width of the conductive vias measured in the line width direction, and less than or equal to twice the width of the conductive vias measured in the line width direction.

11. The coil component of claim 9, wherein a line width of the first pad region is greater than or equal to a width of the conductive vias measured in the line width direction, and less than or equal to twice the width of the conductive vias measured in the line width direction.

12. The coil component of claim 1, wherein one end of the at least one second coil is connected to the second external electrode, and a region on an opposite end of the at least one second coil, connected to the plurality of conductive vias, is referred to as a second pad region, and
a line width of the second pad region in the at least one second coil is substantially equal to a line width of a different region of the at least one second coil connected to the second pad region.

13. The coil component of claim 1, wherein one end of the at least one second coil is connected to the second external electrode, and a region on an opposite end of the at least one second coil, connected to the plurality of conductive vias, is referred to as a second pad region,
a line width of the second pad region in the at least one second coil is greater than a line width of a different region of the at least one second coil connected to the second pad region.

14. The coil component of claim 12, wherein a line width of the second pad region is greater than or equal to a width of the conductive vias measured in the line width direction, and less than or equal to twice the width of the conductive vias measured in the line width direction.

15. The coil component of claim 13, wherein a line width of the second pad region is greater than or equal to a width of the conductive vias measured in the line width direction and less than or equal to twice the width of the conductive vias measured in the line width direction.

16. The coil component of claim 1, wherein the plurality of conductive vias are arranged in one direction.

17. The coil component of claim 1, wherein the plurality of conductive vias comprise three or more of conductive vias.

18. A coil component comprising:
a body;
an insulating layer disposed in the body;
at least one first coil and at least one second coil disposed on opposing surfaces of the insulating layer;
a plurality of conductive vias spaced apart from one another and connecting the at least one first coil and the at least one second coil through the insulating layer;
a first external electrode and a second external electrode disposed on the body and connected to the at least one first coil and the at least one second coil, respectively,
wherein a portion of each of the plurality of conductive vias is exposed from a side surface of the insulating layer.

19. The coil component of claim 18, wherein each of the plurality of conductive vias includes an exposed side surface uncovered by and exposed from the side surface of the insulating layer, and the exposed side surface is coplanar with the side surface of the insulating layer.

20. The coil component of claim 19, wherein the exposed side surface is coplanar with one side surface of the at least one first coil and one side surface of the at least one second coil.

21. The coil component of claim 19, wherein the exposed side surface is a flat surface.

22. The coil component of claim 19, wherein the exposed side surface is exposed in a direction toward a core of the at least one first coil or a core of the at least one second coil.

23. The coil component of claim 19, wherein the plurality of side surfaces includes an unexposed side surface covered by a portion of the insulating layer, and the unexposed side surface comprises a curved surface.

24. The coil component of claim 18, wherein one end of the at least one first coil is connected to the first external electrode, and a region on an opposite end of the at least one first coil, connected to the plurality of conductive vias, is referred to as a first pad region, and
a line width of the first pad region in the at least one first coil is substantially equal to a line width of a different region of the at least one first coil connected to the first pad region.

25. A coil component comprising:
a body;
an insulating layer disposed in the body;
at least one first coil disposed on a first surface of the insulating layer;
at least one second coil disposed on a second surface of the insulating layer;
at least one conductive via connecting the at least one first coil and the at least one second coil;
a first external electrode disposed on the body and connected to the at least one first coil; and
a second external electrode disposed on the body and connected to the at least one second coil,
wherein the at least one conductive via includes a side surface at least partially exposed from the insulating layer, and
the at least one first coil includes a first pad region to which the at least one conductive via is connected, and a line width of the first pad region in the at least one first coil is substantially equal to a line width of a different region of the at least one first coil connected to the first pad region.

26. The coil component of claim 25, wherein the at least one second coil includes a second pad region to which the at least one conductive via is connected, and a line width of the second pad region in the at least one second coil is substantially equal to a line width of a different region of the at least one second coil connected to the second pad region.

27. The coil component of claim 25, wherein the at least one conductive via comprises a plurality of conductive vias arranged in an extending direction of the at least one first coil or the at least one second coil and spaced apart from one another with an interval.

28. The coil component of claim 27, wherein the plurality of conductive vias include side surfaces, respectively, that are coplanar with a side surface of the insulating layer.
